(19) United States
(12) Patent Application Publication
(10) Pub. No.: US 2004/0006918 A1
(43) Pub. Date: Jan. 15, 2004

(54) Mechanical memory for a movable barrier operator and method

(75) Inventor: James Fitzgibbon, Batavia, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/195,802

(22) Filed: Jul. 15, 2002

(51) Int. Cl. E05F 15/02

(52) U.S. Cl. 49/28

(57) ABSTRACT

A mechanical memory as used with a movable barrier operator serves to provide characterizing codes and/or executable code to the movable barrier operator. In one embodiment the mechanical memory is integrated with an RPM cup (20). The mechanical memory includes physical aspects that interact in a predetermined way with energy such as, for example, light. This interaction can include passage, reflection, and absorption. Regular placement of at least some of the physical aspects can be used to permit real-time monitoring of at least one operating parameter of the movable barrier operator (such as motor speed or movable barrier position). In addition, these and/or additional physical aspects can be modified to correlate to data, such as bits or symbols, that represent the operator code.

### TECHNICAL FIELD

This invention relates generally to movable barrier operators and more particularly to the programming thereof.

### BACKGROUND

Movable barrier operators are known in the art. Such operators typically include or cooperate with a motive mechanism, such as an electric motor, to cause selective movement of one or more corresponding movable barriers (such as, for example, garage doors, swinging and sliding gates, rolling shutters, and the like). Manufacturers of such operators often provide a wide variety of models to the consuming public, which models are often differentiated not only by appearance but by functionality and features as well.

Unfortunately, when each such model constitutes an independent platform that is distinct from the design of other models offered by the same manufacturer, costs driven by independent design, manufacturing needs, inventory, and so forth tend to be relatively high. Therefore, notwithstanding the practical need to address a given marketplace with a variety of models, a typical manufacturer is often also inclined towards use of a single common platform to thereby minimize such costs. To date, it has been difficult to reconcile these competing needs.

Prior art approaches include the use of jumper cables or breakable conductive paths that facilitate relatively crude functionality and/or feature assignment for a given multi-model platform. Switches, such as DIP switches, are also used in a similar way and portable flash memories of various kinds have also been proposed. Though effective for some limited purposes, such approaches tend, in various cases, to be relatively permanent once an assignment has been made, error prone, subject to unauthorized manipulation, and not well suited for use with a platform that can support a significant number of assignable functions and features.

### BRIEF DESCRIPTION OF THE DRAWINGS

The above needs are at least partially met through provision of the mechanical memory for a movable barrier operator and method described in the following detailed description, particularly when studied in conjunction with the drawings, wherein:

FIG. 1 comprises a block diagram as configured in accordance with various embodiments of the invention;

FIG. 2 comprises a perspective view of an RPM cup as configured in accordance with prior art technique;

FIG. 3 comprises a planar view of the RPM cup of FIG. 2;

FIGS. 4 and 5 comprise an enlarged schematic cutaway view of an RPM cup reader as configured in accordance with prior art technique;

FIG. 6 comprises a timing diagram as corresponds to a prior art RPM cup;

FIG. 7 comprises a flow diagram as configured in accordance with various embodiments of the invention;

FIG. 8 comprises a planar view of a mechanical memory as configured in accordance with various embodiments of the invention;

FIG. 9 comprises a timing diagram that corresponds to the mechanical memory of FIG. 8;

FIG. 10 comprises a planar view of a mechanical memory as configured in accordance with another embodiment of the invention;

FIG. 11 comprises a planar view of a mechanical memory as configured in accordance with yet another embodiment of the invention;

FIG. 12 comprises a planar view of a mechanical memory as configured in accordance with yet another embodiment of the invention;

FIG. 13 comprises a flow diagram as configured in accordance with another embodiment of the invention;

FIG. 14 comprises an enlarged, cutaway, perspective view of a mechanical memory as configured in accordance with another embodiment of the invention;

FIG. 15 comprises a large schematic cutaway view of a reader and mechanical memory as configured in accordance with another embodiment of the invention;

FIG. 16 comprises a planar view of a mechanical memory as configured in accordance with yet another embodiment of the invention; and

FIG. 17 comprises a detailed, cutaway, perspective view as configured in accordance with yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a mechanical memory adapted and configured for operable coupling to a movable barrier operator (such as, for example, by coupling to a movable barrier operator motor) serves to provide data. This data, when read, can be used to control the movable barrier operator. In one embodiment, this data comprises programming data for the movable barrier operator. The programming data in this embodiment may be stored in corresponding physical aspects of the mechanical memory, which physical aspects are characterized by at least one energy interactive feature. For example, in various embodiments, the energy interactive feature can be any of a light reflecting surface, a light occluding surface, and/or a light absorbing surface (wherein “light” includes both visible and non-visible light energy). Various quantities of data are storable depending upon the number and type of physical aspects employed.

If desired, the mechanical memory can also include one or more data frame identifiers. In a preferred embodiment, the mechanical memory also serves a parallel purpose in that one or more physical aspects (which physical aspects may or may not also represent data as desired) are adapted and configured to represent specific corresponding positions of, for example, a motive mechanism (such as a motor) for the movable barrier operator. So configured, for example, speed of the motive mechanism and/or a relative position of a corresponding movable barrier can be ascertained through appropriate monitoring of such physical aspects.

Such a mechanical memory can be used for a wide variety of purposes. For example, such mechanical memories can serve to cause a given movable barrier operator to utilize a given set of features and functions from amongst a plurality of pre-programmed features and functions. In this way, a multi-model operator platform can be used to provide a wide variety of operator models and brands. By simply installing a given mechanical memory, such an operator can be readily programmed to “be” a given corresponding model of operator. When the mechanical memory also serves a parallel purpose, such as providing position information of the movable barrier operator motor, this capability becomes available for virtually little or no incremental cost, as the physical device itself and the corresponding reader are already necessary elements of the system.

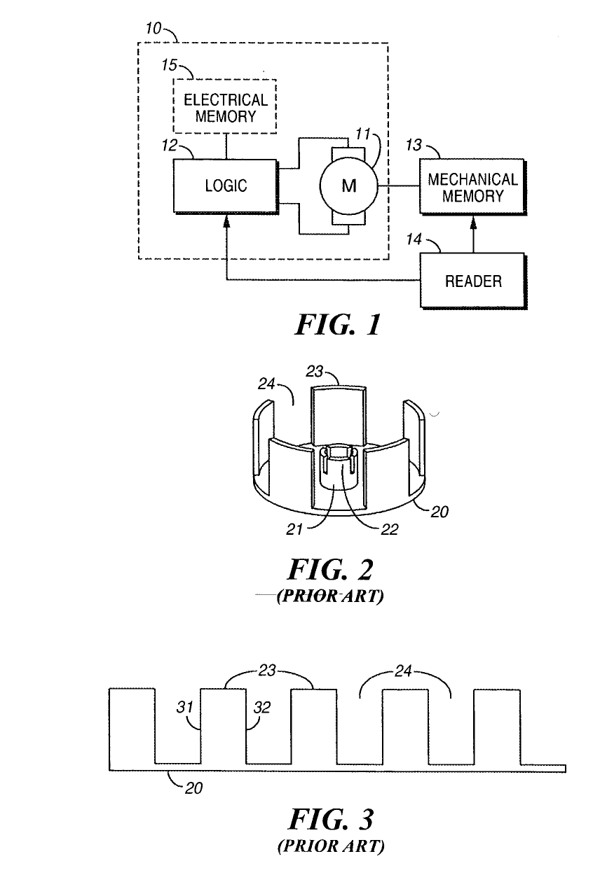

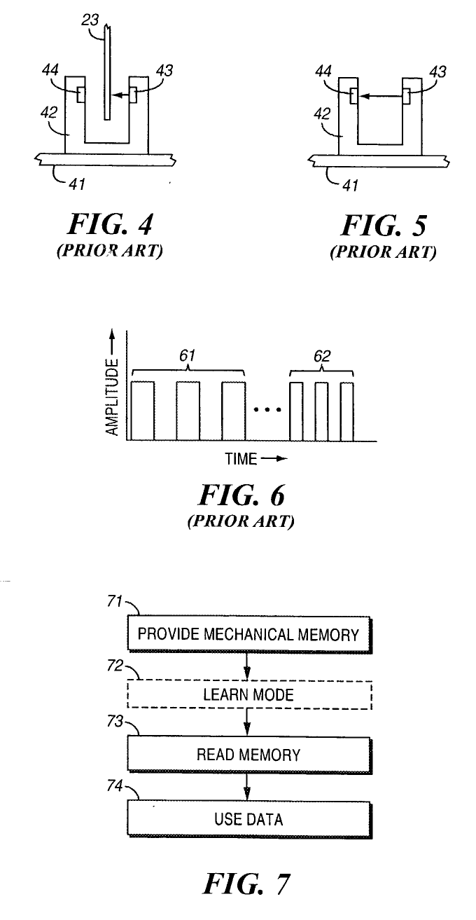

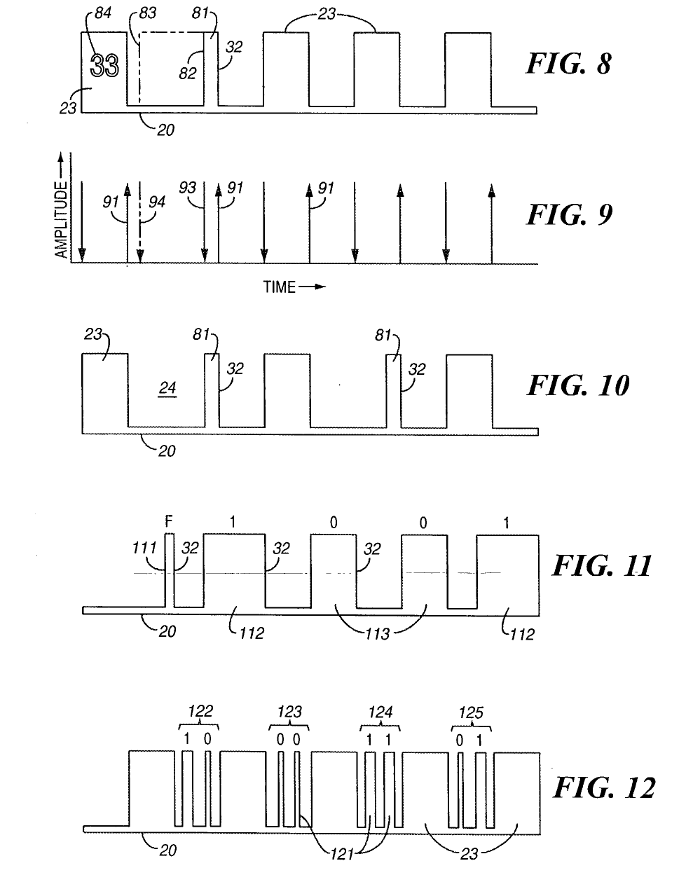

Referring now to FIG. 1, a movable barrier operator system includes a movable barrier operator 10 that typically includes a motor 11 (to impart desired movement to a movable barrier, such as, for example, a garage door, a sliding or swinging gate, a rolling shutter, and so forth (not shown), in accordance with well understood prior art technique) and a logic platform 12 (such as a microprocessor, microcontroller, discrete circuitry, programmable gate array, and so forth as well understood in the art). So configured, the logic platform 12 comprises a programmable platform that can be readily programmable to perform a wide variety of functions and features as a movable barrier operator (including, for example, opening and closing the movable barrier in response to local or remote commands and/or in response to other stimuli such as time of day or time since last operation, stopping and/or reversing movement of the movable barrier upon detecting a possible obstacle in the path of the movable barrier, remote controller verification and/or programming, intrusion detection, environmental lighting control, and so forth, to name a few). Such components and corresponding functionality are well understood in the art and hence additional elaboration will not be offered here for the sake of brevity and preservation of focus.

In this embodiment, a mechanical memory 13 operably couples to a rotatable portion of the motor 11 (various embodiments of such a mechanical memory are presented below) such as, for example, by coupling to an output shaft of the motor 11. Positioned in this way, movement of the motor 11 will cause a corresponding movement of the mechanical memory. As will be shown in more detail below, the mechanical memory 13 serves at least in part to store one or more elements of data, such as programming data, for use by the movable barrier operator 10 (and particularly, in this embodiment, the logic platform 12). To facilitate this, a reader 14 as operably coupled to the logic platform 12 reads the mechanical memory 13 to obtain such data. For example, in a preferred embodiment, the reader 14 is adapted and configured to sense energy interactive features that comprise at least a part of the mechanical memory 13 to thereby read movable barrier operator programming data. As will be shown below, such can be accomplished by having the reader respond to radiated energy signals that correspond to one or more discrete data elements that together comprise the movable barrier operator programming data (the radiated energy can either be sourced via the mechanical memory and/or reflected therefrom depending upon the embodiment selected).

Typically, the movable barrier operator 10 will include at least one electrical memory 15 (such as, for example, a RAM, EPROM, EEPROM, MRAM, and the like). The electrical memory 15 will often serve to store programming data for the movable barrier operator including both executable instructions and various tables containing operating parameters and the like. In such an embodiment, the programming data as read by the reader 14 from the mechanical memory 13 can be readily stored in the electrical memory 15 for immediate and/or subsequent usage.

In a preferred embodiment, the mechanical memory 13 can be integrated with, for example, a so-called RPM wheel or cup. Such cups are well understood in the art. Nevertheless, for purposes of understanding various integrated embodiments presented below, it will be helpful to first describe such prior art RPM cups. Referring now to FIG. 2, an RPM cup 20 typically comprises a disc-shaped rotatable member formed of plastic and having an axially disposed column 21 coupled thereto. The column 21 is adapted and configured to fit snugly over an output shaft of a movable barrier operator motor (or any shaft or similar member driven directly or indirectly by the output shaft of the motor). To facilitate such placement, the column 21 may itself be comprised of a plurality of flexible members 22 whose flexibility permits ease of initial placement and whose resiliency serves to retain the RPM cup 20 in place once so positioned. If desired, a constricting band, set screw, or other device can be used to aid in assuring fixed placement of such an RPM cup.

A plurality of aspects comprising arcuately-shaped walls 23 are disposed about the perimeter of the disk. These walls 23, along with the intervening spaces 24 disposed therebetween and which serve to define the edges of the walls 23, are usually evenly spaced around the circumference of the RPM cup 20 and, during use, provide data corresponding to one or more parameters of the movable barrier operator (such as speed of the motor, RPM, position of the movable barrier itself (by, for example, counting pulses traveled in a given direction from a given starting position), and direction of movement).

FIG. 3 provides another way of viewing the walls 23 and intervening gaps 24 of such an RPM cup 20. In particular, FIG. 3 comprises a planar view of the RPM cup 20 as though the perimeter of the cup 20 were laid out flat. This view may be helpful to understanding and appreciating the operation and use of the RPM cup 20. For example, this view clearly illustrates that each wall 23 is defined in part by a leading edge 32 and a trailing edge 31. It can also be seen that there is an approximate 50% apportionment as between the walls 23 and the gaps 24.

In this particular embodiment, the walls 23 are comprised of a material that serves to occlude the passage of light.

With reference to FIG. 4, when such a wall 23 is disposed within a reader 42 (as is typically mounted on an appropriate printed wiring board 41 or other supporting substrate, frame, or bracket), light as sourced by a light source 43 (such as an LED) will be blocked by the wall 23. Conversely, as shown in FIG. 5, when there is no wall 23 so positioned in the reader 42 (as when the RPM cup 20 has moved such that one of the gaps 24 is now aligned with the reader 42), light from the light source 43 travels unimpeded to a light sensor 44 (such as a photosensitive active device). So configured, such a reader 42 can readily detect the presence or absence of an occluding wall 23 and, more particularly, can detect the transition between gap 24 and wall 23 and vice versa. Therefore, the reader 42 is capable of sensing both the leading edge 32 and the trailing edge 31 of the walls 23 of the RPM cup 20.

By regularly spacing the walls 23, and more particularly the leading edges 32 and/or the trailing edges 31 of the walls 23, around the perimeter of the RPM cup 20, predetermined edges (leading and/or trailing) can be sensed to thereby detect movement of the motor output shaft. As illustrated in FIG. 6, electrical pulses generated by the reader 42 in response to detecting leading edges will tend to be regularly spaced over time at any given speed. Of course, pulses 61 that correspond to movement of the RPM cup 20 at one motor speed will tend to be spaced further apart in time as compared to pulses 62 that correspond to a faster speed of movement. Therefore, as well understood in the art, one can readily calculate speed of rotation of the motor output shaft and hence any number of other corollary operational parameters, including speed of movement of the movable barrier.

Referring now to FIG. 7, pursuant to various embodiments described below, a mechanical memory is provided 71. In a preferred embodiment, such a mechanical memory is integrated with an apparatus such as an RPM cup as generally described above, though it should be understood that such integration is not a necessary aspect of the invention. Also in a preferred embodiment the mechanical memory may uniquely correspond to a specific configuration of the movable barrier operator at issue (or group of operators in an appropriate application); that is, the mechanical memory can itself correlate in some predetermined way with a specific feature (or feature set), function, brand, model, or configuration or combination thereof (although again it is not a necessary aspect of the invention that such a correlation exist). The mechanical memory is then read 73 to retrieve the stored data and used 74 accordingly. Various exemplary ways to encode such data and/or to read such data are set forth below. The reading 73 can be initiated in a variety of ways. For example, the mechanical memory could be read on a regular periodic basis or in response to some significant predetermined occurrence. In one embodiment, a learn mode 72 for the movable barrier operator can be initiated to cause the movable barrier operator to so read the mechanical memory. Such a learn mode can be initiated in a variety of ways, including by a specific user-actuated switch or as an automatic response to initialization.

Referring now to FIG. 8, some initial embodiments of a mechanical memory in accord with these teachings will be described. In these embodiments, the data will be integrated with an RPM cup form factor as generally described above; such configurations are presented for purposes of consistent illustration and clarity and are not to be construed as suggesting that such integration is necessary or that, generally speaking, a cup-like form factor is required.

In a first embodiment, the mechanical memory comprises a cup-shaped object that is readily attached to the output shaft of a movable barrier operator motor such that the mechanical memory will physically move in conjunction with the output shaft. The mechanical memory includes physical aspects comprising five light-occluding walls 23 (and the corresponding light-passing gaps disposed therebetween) that serve to represent at least one movable barrier operator real-time operating parameter (in this case, a specific position of the motor shaft, such that monitoring of the motor shaft over time can be used to ascertain motor speed, movable barrier position, and direction of movement as well understood in the art). In this embodiment, however, one of the physical aspects has been modified to thereby also represent a single bit of data (which data can comprise, for example, movable barrier operator programming data and/or a codeword that corresponds to a predetermined mode of operation of the movable barrier operator). In particular, one wall 81 has been modified to be approximately one half the width of the other walls 23. Therefore, although this wall 81 has a leading edge 32 and trailing edge 82, the distance between these two edges 82 and 32 is less than that of the other walls 23.

This reduction in width for this particular wall 81 is readily detectable. With reference to FIG. 9, the edges 91 as detected by the movable barrier operator electronics, again tend to be relatively evenly spaced at any given speed. The edge 93 that corresponds to the trailing edge 82 for the reduced width wall 81, however, is discernibly closer to its corresponding leading edge 91 and hence is easily detectable. This difference in position is perhaps more readily appreciated by noting where the trailing edge pulse would have appeared instead had this wall not been so modified (as depicted in phantom lines and denoted by reference numeral 94).

By so modifying one of the walls of the RPM cup, and therefore effecting a modification to the corresponding energy-interactive window represented thereby, a quantum element of programming data is mechanically stored and represented. In this embodiment, the data comprises a single bit and therefore would likely not itself constitute executable code. The data could readily serve as a flag that represents, however, a specific operator type, operator feature, and/or operator function or option. Upon reading the data, the movable barrier operator could then, for example, use or not use specific portions of pre-stored programming and/or parameters to conform to the retrieved data.

In the embodiment just described, the data was represented by a wall of reduced width. There are, of course, other ways to physically represent such data. For example, this wall 81 could have an increased width (as suggested by the phantom lines having reference numeral 83) as compared to the remaining walls. Such a difference would again be readily detectable through appropriate monitoring and processing of the resultant reader edge-detection pulses. Other variations with respect to width could also serve as well. Further, multiple differing widths for a single given wall could be used to represent multiple discrete data bits (such an embodiment might be particularly appropriate for use with a reader that uses multiple light sources and/or detectors).

Because such a mechanical memory can serve to program and/or cause a given movable barrier operator to perform in a particular predetermined way (such as a given model of a given brand of movable barrier operator), it may be convenient to include a visual indicia 84 that uniquely identifies the mechanical memory in this regard. For example, the visual indicia 84 could identify the mechanical memory as corresponding to a specific brand or model of movable barrier operator. The visual indicia 84 could be provided in any of a variety of ways including by application of paint, by embossing, by stamping, and so forth.

As described above, a single physical aspect of the mechanical memory can serve to represent one or more data bits. In addition, and referring now to FIG. 10, multiple physical aspects can be used to represent a plurality of data bits. In the embodiment depicted, this concept has been illustrated through provision of two walls 81 that both have a reduced width, which reduced width serves to represent corresponding data bits (or codewords) as otherwise described above. In this way a plurality of data (including executable code when appropriate to the application) items can be stored through use of a plurality of physical aspects (and again, as before, each such wall can itself be used to store a plurality of bits through appropriate formation thereof).

When multiple physical aspects are used to store the data, the order of reading the physical aspects may be important in some applications. One way to meet that need is to provide a data frame identifier or marker as indicated in FIG. 11. The purpose of such an identifier or marker is to indicate a predetermined position within the frame that effectively includes the data bits themselves. In the embodiment depicted, the mechanical memory comprises a single data frame, but of course multiple frames could be provided as desired. The data frame identifier or marker is comprised of a single physical aspect 111; in particular, an occluding surface that has a width of a predetermined size that is unique to the identifier/marker such that it can be readily differentiated from the remaining physical aspects.

So configured, the remaining four physical aspects can serve as data storage cells. In this embodiment, wider aspects 112 serve to represent a logical “1” and medium width aspects 113 serve to represent a logical “0.” Also in this embodiment, the mechanical memory is integrated with an RPM cup 20 such that, in this embodiment, the leading edge 32 of each occluding member will serve to mark a specific position of the movable barrier operator motor output shaft (if desired, of course, the trailing edge could be used instead by reorienting the occluding members accordingly to provide for evenly spaced trailing edges).

In the various embodiments described above, each physical aspect of the mechanical memory serves to store data, mark a data frame location, and/or indicate a predetermined position of the motor for use in determining one or more performance parameters of the operator. If desired, however, the aspects representing data can be interleaved or otherwise distributed amongst or between the position-indicating markers. For example, with reference to FIG. 12, a given RPM cup 20 can be provided with a given number (such as five) motor position-indicating markers 23 that are substantially evenly distributed around the perimeter of the cup 20 as described above. In addition, physical aspects representing data can be interleaved therewith. In this embodiment, to illustrate this concept, each gap between position-indicating markers 23 includes two physical aspects 121 that represent data. Again, these physical aspects 121 can be differentiated from one another using, for example, differences in width between their leading and trailing edges. In the example depicted, a first data pair 122 represents “10,” a second data pair 123 represents “00,” a third data pair 124 represents “11,” and a fourth data pair represents “01.”

If desired, of course, differing numbers of physical aspects could be used to store a corresponding amount of data. Also, as taught earlier, a data frame identifier or marker could be included as well to facilitate reading of the data in a desired sequence.

It should now be well appreciated that data in variable quantities can be stored in a mechanical memory for use with a movable barrier operator. Conveniently, the mechanical memory itself can be combined with other functional elements including an RPM cup. Movement of the mechanical memory (in response to movement of some controllable aspect of the movable barrier operator such as the motor or movable barrier itself) facilitates reading of the data by a corresponding reader. The data itself can constitute (in whole or in part) executable code to be downloaded and thereafter executed by the movable barrier operator or a code or flag to cause the movable barrier operator to function thereafter in a predetermined fashion.

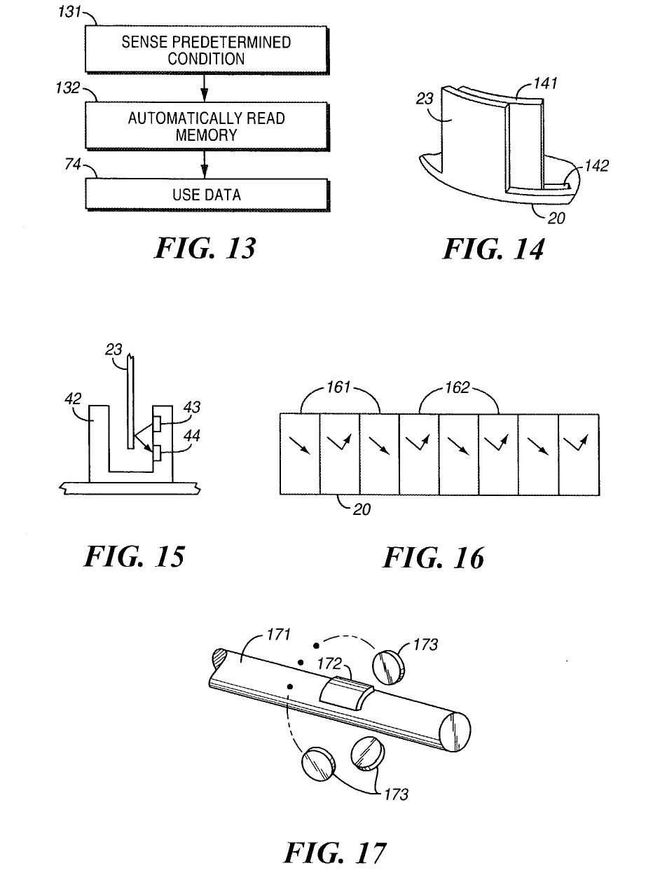

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, with reference to FIG. 13, the reading 132 of the data and subsequent use 74 of the data can be made responsive to a predetermined condition. As one illustration, the movable barrier operator can automatically effect these steps upon sensing that electrical power has been removed for whatever reason (typically, of course, after the electrical power has been restored).

As another example, and referring now to FIG. 14, one or more of the physical aspects of the moveable memory can be made reconfigurable. As one illustration, a part 23 of the physical aspect can be substantially permanent (to ensure appropriate marking, for example, of a position on the motor shaft) while another part 141 can be made movable (within, for example, a slot 142 provided therefore). So configured, the width of such a physical aspect could be altered to thereby in effect permit storing dynamically variable data. This would permit, for example, a service person to configure the mechanical memory as appropriate for a given installation prior to installing the mechanical memory. There are many other ways, of course, that reconfigurable physical elements could be provided (through use of, for example, break-away elements, insertable elements, and so forth).

As yet another example, the mechanical memory can operate other than with occluding and non-occluding surfaces to differentiate data elements. For example, with reference to FIGS. 15 and 16, the energy interactive windows of the mechanical memory could be comprised of light absorbing 161 and reflective 162 surfaces. The absorbing and reflective nature of the window proximal at any given time to the reader 42 could be readily detected through use of a light source 43 and detector 44 that are appropriately positioned to sense reflected light. So configured, the width of the windows could again be varied to correspond to data as before. In the alternative (or in addition) it is possible that the degree of reflectivity could be controlled to also correspond to specific data elements. Also, if desired, such use of absorbing and reflecting surfaces could be combined with occluding and non-occluding aspects as taught above.

As yet another example, and referring now to FIG. 17, other kinds of energy-interactive windows and radiated energy signals could be used to similar effect and purpose. In the particular example shown to illustrate this point, an output shaft 171 of a movable barrier operator motor (not shown) has a magnet 172 affixed thereto. A plurality of magnetic sensors 173 (such as, for example, Hall effect sensors) are arrayed around the shaft 171 and held in position through use of a bracket (not shown) or other appropriate mechanism. So configured, the sensors 173 can readily detect movement of the magnet 172 and hence the corresponding position of the shaft 171. Therefore, it is also possible to arrange one or more of the sensors 173 (or to use multiple magnets having, for example, varying widths) to represent data as is otherwise described above.

We claim:

1. A method comprising:
operably coupling a mechanical memory to a movable barrier operator;
reading data stored in the mechanical memory;
using at least some of the data to control the movable barrier operator.

2. The method of claim 1 wherein the mechanical memory comprises a plurality of occluding surfaces.

3. The method of claim 2 wherein the occluding surfaces correspond to stored data.

4. The method of claim 1 wherein the mechanical memory comprises a plurality of physical aspects.

5. The method of claim 4 wherein at least some of the plurality of physical aspects comprise an energy interactive feature.

6. The method of claim 5 wherein the energy interactive feature comprises at least one of a light reflecting surface, a light occluding surface, and a light absorbing surface.

7. The method of claim 5 wherein the energy interactive feature comprises a magnetic interface.

8. The method of claim 7 wherein the magnetic interface comprises one of a magnet and a magnetically responsive material.

9. The method of claim 4 wherein at least one of the plurality of physical aspects corresponds to a single bit of data.

10. The method of claim 4 wherein at least one of the plurality of physical aspects corresponds to a plurality of bits of data.

11. The method of claim 1 and further comprising using the mechanical memory to ascertain at least one of present speed of movement of the movable barrier operator and present position of a movable barrier.

12. The method of claim 1 wherein reading data includes physically moving the mechanical memory.

13. The method of claim 12 wherein physically moving the mechanical memory includes moving at least a part of the movable barrier operator.

14. The method of claim 13 wherein moving at least a part of the movable barrier operator includes actuating a motor.

15. The method of claim 1 wherein reading data includes placing the movable barrier operator in a learning mode of operation.

16. The method of claim 1 wherein reading data includes sensing that electrical power to the movable barrier operator has been removed and automatically reading the data subsequent to restoration of the electrical power.

17. A method comprising:
providing a mechanical memory;
reading data stored in the mechanical memory;
using at least some of the data to control a movable barrier operator.

18. An apparatus comprising:
a movable barrier operator;
a mechanical memory that is operably coupled to the movable barrier operator,
wherein the mechanical memory includes movable barrier operator programming data.

19. The apparatus of claim 18 wherein the movable barrier operator includes a logic platform, which logic platform includes at least one electrical memory having programming data stored therein as at least partially derived from the movable barrier operator programming data.

20. The apparatus of claim 18 wherein the mechanical memory includes a plurality of physical aspects, wherein at least one of the physical aspects represent the movable barrier operator programming data.

21. The apparatus of claim 20 wherein at least some of the plurality of physical aspects comprise energy interactive features.

22. The apparatus of claim 21 wherein the movable barrier operator includes a reader adapted and configured to sense the energy interactive features to thereby read the movable barrier operator programming data.

23. The apparatus of claim 20 wherein at least one of the plurality of physical aspects comprises a data frame identifier.

24. The apparatus of claim 20 wherein the movable barrier operator programming data comprises at least one codeword that corresponds to a predetermined mode of operation of the movable barrier operator.

25. The apparatus of claim 20 wherein the movable barrier operator includes a motive mechanism that is adapted and configured to be operably coupled to a movable barrier.

26. The apparatus of claim 25 wherein the mechanical memory is operably coupled to the motive mechanism such that at least some movement of the motive mechanism will cause a corresponding movement of the mechanical memory.

27. The apparatus of claim 26 wherein at least some of the plurality of physical aspects of the mechanical memory are adapted and configured to represent specific corresponding positions of the motive mechanism.

28. The apparatus of claim 18 wherein the mechanical memory includes data means for representing elements of the movable barrier operator programming data as physical aspects.

29. The apparatus of claim 28 wherein the physical aspects comprise specific predetermined actions with respect to at least one of:
returning a predetermined radiated energy signal; and
sourcing a predetermined radiated energy signal;
wherein the predetermined radiated energy signal corresponds to discrete data elements that together comprise the movable barrier operator programming data.

30. A method of programming a movable barrier operator, comprising:
selecting a mechanical memory that uniquely corresponds to a specific group configuration of the movable barrier operator to provide a selected mechanical memory;
coupling the selected mechanical memory to the movable barrier operator.

31. The method of claim 30 wherein selecting a mechanical memory that uniquely corresponds to a specific group configuration of the movable barrier operator includes selecting a mechanical memory that uniquely corresponds to a desired feature set for the group configuration.

32. The method of claim 30 wherein selecting a mechanical memory that uniquely corresponds to a specific group configuration of the movable barrier operator includes selecting a mechanical memory that uniquely corresponds to a specific brand of movable barrier operator.

33. The method of claim 30 wherein selecting a mechanical memory that uniquely corresponds to the specific group configuration of the movable barrier operator includes selecting a mechanical memory having visible indicia disposed thereon that uniquely identifies the mechanical memory.

34. The method of claim 30 wherein selecting a mechanical memory that uniquely corresponds to the specific group configuration of the movable barrier operator includes making physical adjustments to the mechanical memory, which physical adjustments represent changes to corresponding data.

35. An apparatus comprising:
a movable barrier operator having a motor and a sensor;
a mechanical memory having a plurality of physical aspects, wherein each of the physical aspects behaves in a predetermined way with respect to a specific predetermined radiated energy and which behavior is detectable by the sensor,
wherein the mechanical memory is operably coupled with respect to the motor such that operation of the motor will cause a corresponding movement of the mechanical memory, and the corresponding movement of the mechanical memory will cause a corresponding movement of the physical aspects that in turn faciliates detection of the physical aspects by the sensor.

36. The apparatus of claim 35 wherein at least one of the physical aspects represent corresponding movable barrier operator programming data.

37. The apparatus of claim 36 wherein at least some of the physical aspects represent at least one movable barrier operator real-time operating parameter.

38. The apparatus of claim 36 wherein at least a portion of one of the physical aspects represents a data frame marker.

39. The apparatus of claim 38 wherein at least 4 programming data bits are represented by the physical aspects.

40. The apparatus of claim 35 wherein the physical aspects are configured and arranged such that, when the motor is operating at a substantially constant velocity, portions of each physical aspect that correspond to a detectable edge are spaced substantially equal from one another.

41. The apparatus of claim 35 wherein the mechanical memory comprises an RPM wheel.

42. A method of providing movable barrier operator programming data to a movable barrier operator, comprising:
providing a plurality of energy-interactive windows wherein at least a portion of at least some of the energy-interactive windows represent corresponding specific movable barrier operator positions, which positions are detectable and usable by the movable barrier operator to sense at least one of speed of movement and position of a movable barrier;
modifying at least one of the plurality of energy-interactive windows to also represent movable barrier operator programming data.

43. The method of claim 42 wherein modifying at least one of the plurality of energy-interactive windows includes modifying at least one of the energy-interactive windows to both represent movable barrier operator programming data and a specific corresponding movable barrier operator position.

44. The method of claim 42 wherein modifying at least one of the plurality of energy-interactive windows includes adding additional energy-interactive windows to the energy-interactive windows, wherein the additional energy-interactive windows represent the movable barrier operator programming data.

45. A mechanical memory for use with a movable barrier operator, comprising:
first mechanical means for providing information to the movable barrier operator regarding at least one substantially real-time operating parameter; and
second mechanical means for providing programming data to the movable barrier operator.

46. The mechanical memory of claim 45 wherein the programming data identifies one of a plurality of predetermined operating modes for the movable barrier operator.

47. The mechanical memory of claim 45 wherein the programming data comprises at least some executable code.

48. An apparatus for identifying a parameter of a movable barrier operator comprising:
a rotatable member;
a mechanism for coupling the rotatable member to a motive mechanism such that movement of the motive mechanism results in a corresponding movement of the rotatable member; and
a plurality of aspects connected to the rotatable member and being configured to provide data corresponding to a parameter of the movable barrier operator such that the parameter may thereby be identified.

49. An apparatus according to claim 48 wherein the rotatable member is generally disk-shaped.

50. An apparatus according to claim 48 wherein the coupling mechanism comprises a column with which at least a portion of the motive mechanism may be connected.

51. An apparatus according to claim 50 wherein the column comprises flexible members to accompany motive mechanisms of varying sizes.

52. An apparatus according to claim 48 wherein the plurality of aspects comprise spaced apart arcuately shaped walls extending from the circumference of the rotatable member for providing data corresponding to a parameter of the movable barrier operator.

53. An apparatus according to claim 52 wherein the data provided is at least one of speed, RPM, position, and direction.

54. An apparatus according to claim 48 wherein at least one of the plurality of aspects is shaped for providing data corresponding to a parameter of the movable barrier operator.

55. An apparatus according to claim 54 wherein the data provided is at least one of operator type, operator feature and operator function.

56. An apparatus according to claim 48 further comprising indicia for visually identifying the apparatus.
